(19) United States
(12) Patent Application Publication
(10) Pub. No.: US 2025/0166072 A1
(43) Pub. Date: May 22, 2025

(54) MANAGING PLAIN TEXT SMART CONTRACTS

(71) Applicant: AMERICAN EXPRESS TRAVEL RELATED SERVICES COMPANY, INC., New York, NY (US)

(72) Inventor: Andras L. FERENCZI, Scottsdale, AZ (US)

(73) Assignee: AMERICAN EXPRESS TRAVEL RELATED SERVICES COMPANY, INC., New York, NY (US)

(21) Appl. No.: 18/512,621

(22) Filed: Nov. 17, 2023

(51) Int. Cl. G06Q 40/06

(52) U.S. Cl. CPC G06Q 40/06

(57) ABSTRACT

A plain text smart contract may be sent to a plurality of nodes associated with a distributed ledger. Each node of the plurality of nodes may be configured and/or associated with a respective large language model trained to interpret plain text. A plain text description of a transaction for the smart contract may be sent to the plurality of nodes. The transaction may be validated based on consensus information received from at least a portion of nodes of the plurality of nodes. A respective portion of the consensus information may be generated by each node of the at least the portion of nodes based in part on at least a portion of the plain text smart contract stored by the node compared to the plain text description of the transaction by the respective large language model.

### BACKGROUND

Smart contracts are stored on a blockchain and executed when predetermined conditions are met. Smart contracts are typically used to automate the execution of an agreement so that all participants can be immediately certain of the outcome. Smart contracts may also automate a workflow by triggering the actions when conditions are met. Conventionally, smart contracts are written in programming languages specifically designed for blockchain platforms. Validating nodes of blockchain platforms validate transactions related to smart contracts by checking the syntax and structure of the transaction written in a programming language, verifying its digital signature, and ensuring that it complies with the rules specified by the smart contract. As such, the implementation and analysis of smart contracts and their execution within a distributed ledger system, such as a blockchain system, requires complex coding and necessitates expertise in both programming languages and legal contract formation.

### BRIEF DESCRIPTION OF THE DRAWINGS

The accompanying drawings are incorporated herein and form a part of the specification.

FIG. 1 shows a block diagram of an example system for managing plain text smart contracts, according to some aspects of this disclosure.

FIG. 2 shows an example blockchain that supports plain text smart contracts, according to some aspects of this disclosure.

FIG. 3 shows an example plain text smart contract template, according to some aspects of this disclosure.

FIG. 4 shows a flowchart of an example method for managing plain text smart contracts, according to some aspects of this disclosure.

FIG. 5 shows an example computer system useful for implementing various aspects of this disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for managing plain text smart contracts. A plain text smart contract may be sent to a plurality of nodes associated with a distributed ledger. Each node of the plurality of nodes may be configured and/or associated with a respective large language model trained to interpret plain text. A plain text description of a transaction for the smart contract may be sent to the plurality of nodes. The transaction may be validated based on consensus information received from at least a portion of nodes of the plurality of nodes. A respective portion of the consensus information may be generated by each node of the at least the portion of nodes based in part on at least a portion of the plain text smart contract stored by the node compared to the plain text description of the transaction by the respective large language model.

The system, apparatus, device, method and/or computer program product embodiments, and/or combinations and sub-combinations thereof, for managing plain text smart contracts, as described herein, enable transactions and contracts to be stored in plain text, such that they are easily readable by anyone with proper authorization, security credential, and/or valid access. Any blockchain and/or distributed ledger configured as described herein to support plain text smart contracts and transactions remains immutable and cryptographically protected. These and other advantages are described herein.

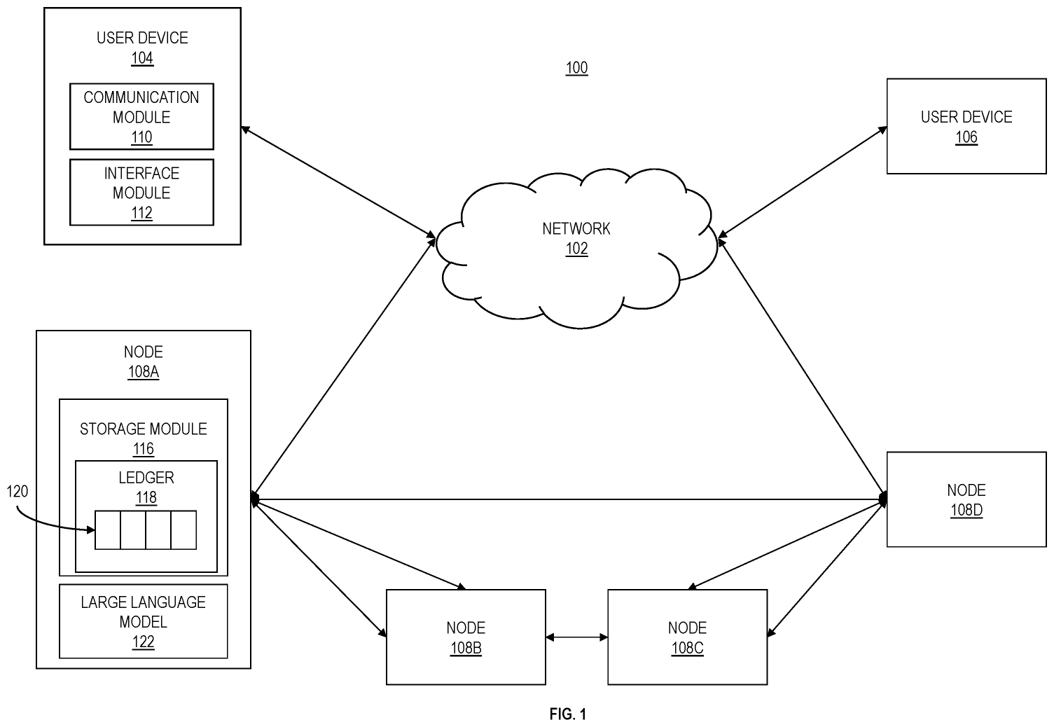

FIG. 1 shows an example system 100. System 100 may facilitate and/or support managing plain text smart contracts. System 100 is merely an example of one suitable environment and is not intended to suggest any limitation as to the scope of use or functionality of aspects described herein. System 100 should not be interpreted as having any dependency or requirement related to any single device/module/component or combination of devices/modules/components described therein.

System 100 may include a network 102. According to some aspects of this disclosure, network 102 may include a packet-switched network (e.g., internet protocol-based network), a non-packet-switched network (e.g., quadrature amplitude modulation-based network), and/or the like. According to some aspects of this disclosure, network 102 may include network adapters, switches, routers, modems, and the like connected through wireless links (e.g., radiofrequency, satellite) and/or physical links (e.g., fiber optic cable, coaxial cable, Ethernet cable, or a combination thereof). According to some aspects of this disclosure, network 102 may include public networks, private networks, wide area networks (e.g., Internet), local area networks, and/or the like. According to some aspects of this disclosure, network 102 may facilitate and/or support any short-range communication techniques (e.g., ultra-wideband (UWB), BLUETOOTH®, near-field communication, infrared, etc.) and/or long-range communication techniques (e.g., Internet, cellular, satellite, and the like). According to some aspects of this disclosure, network 102 may provide and/or support communication between a user device 104, a user device 106, and/or nodes 108A-108D of system 100.

According to some aspects of this disclosure, user device 104 may include a computing device, a smart device, a mobile device, and/or any other device capable of communicating with network 101 and/or device/components in communication with network 101. According to some aspects of this disclosure, although user device 104 is shown and described in greater detail than user device 106, user devices 104 and 106 may be similarly configured and perform similarly and/or execute/operate with the same functionality.

According to some aspects of this disclosure, user device 104 may include a communication module 110 that facilitates and/or enables communication with network 102 (e.g., devices, components, and/or systems of the network 102, etc.), other user devices (e.g., user device 106, etc.), nodes 108A-108D, and/or any other device/component of the system 100. For example, communication module 110 may include hardware and/or software to facilitate communication. Communication module 110 may include one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. Communication module 110 may include any hardware and/or software to facilitate communication.

According to some aspects of this disclosure, communication module 110 may send messages and/or information to send a message to nodes 108A-108D of the distributed system. The messages and/or information (e.g., plain text smart contracts, plain text descriptions of transactions related to plain text smart contracts, etc.) may carry a digital signature of the user device 104. The digital signature may be verified by a node operating as a leader node for the nodes 108A-108D. For security, a digital signature of the leader node may be added to messages and/or information received from user device 104 when the messages and/or information are forwarded to follower nodes of nodes 108A-108D. Communication module 110 may be configured to receive a result (e.g., information related to validated plain text smart contracts, information related to validated plain text descriptions of transactions related to plain text smart contracts, etc.).

User device 104 may include an interface module 112. Interface module 112 enables a user to interact with network 102 (e.g., devices, components, and/or systems of the network 102, etc.), other user devices (e.g., user device 106, etc.), nodes 108A-108D, and/or any other device/component of the system 100. Interface module 112 may include any interface for presenting and/or receiving information to/from a user including, but not limited to, plain text smart contracts, plain text smart transactions, and/or information related to plain text smart contracts and/or plain text smart transactions.

Interface module 112 may include any interface for presenting and/or receiving information to/from a user. According to some aspects of this disclosure, interface module 106 may include a web browser, a user interface of an application, and/or the like. Other software, hardware, and/or interfaces can be used to provide communication between user device 104, network 102 (e.g., devices, components, and/or systems of the network 102, etc.), other user devices (e.g., user device 106, etc.), nodes 108A-108D, and/or any other device/component of the system 100. According to some aspects of this disclosure, interface module 106 may be used to display, request, and/or send data/information including, but not limited to, plain text smart contracts, plain text descriptions of transactions, and/or the like from a local source and/or a remote source, such as network 102 (e.g., devices, components, and/or systems of the network 102, etc.), other user devices (e.g., user device 106, etc.), nodes 108A-108D, and/or any other device/component of the system 100. According to some aspects of this disclosure, interface module 112 may be and/or may include any interface for presenting and/or receiving information to/from a user.

Interface module 112 may include one or more input devices and/or components, for example, such as a keyboard, a pointing device (e.g., a computer mouse, remote control), a microphone, a joystick, a tactile input device (e.g., touch screen, gloves, etc.), and/or the like. According to some aspects, interaction with the input devices and components may enable a user to view, access, manipulate, and/or combinations thereof (and the like), plain text smart contracts, plain text descriptions of transactions, and/or information related to plain text smart contracts and plain text descriptions of transactions. According to some aspects, interaction with the input devices or components may enable a user to submit requests for smart contracts and/or related plain text-based transactions to be generated, manipulated, reviewed, verified, etc.

User devices 104 and 106 may include storage modules (not shown). Storage modules may include and/or store digital wallets (and/or digital wallet services) associated with accounts for user devices 104 and 106 (and/or users of user devices 104 and 106). A digital wallet (and/or digital wallet service) may be used to settle transactions between user devices 104 and 106 associated with a plain test smart contract. According to some aspects of this disclosure, storage modules of user devices 104 and 106 may include payment information, passwords, transaction encryption keys, and/or communication encryption keys associated with the digital wallet associated with a corresponding payment account. For example, the digital wallet may include payment card information. The payment card may be associated with a primary account number (PAN) that may be tokenized for security. PANs associated with queuing system accounts may be stored by account database 150. According to some aspects of this disclosure, monetary assets may be transferred between payment accounts associated with the digital wallet service information stored in storage modules of user devices 104 and 106. For example, digital wallet service information may identify a digital wallet. The digital wallet may correspond to an asset account, financial account, blockchain wallet, and/or any other digital account capable of settling transactions described using plain text.

According to some aspects of this disclosure, system 100 may include blockchain and/or distributed system nodes that facilitate and/or support the management of plain text smart contracts. For example, system 100 may include nodes 108A-108D. According to some aspects of this disclosure, nodes 108A-108D may include computing devices, smart devices, mobile devices, and/or any other device capable of communicating with network 102 and/or devices/components in communication with network 102. Nodes 108A-108D may participate in running the protocol software of a peer-to-peer and/or decentralized network.

According to some aspects of this disclosure, nodes 108A-108D may each be associated with a unique public/private key pair and a network address. According to some aspects of this disclosure, the unique public/private key pair may include a public key and/or a private key. According to some aspects of this disclosure, the network addresses for nodes 108A-108D may include information derived from the unique public/private key pair of the node. According to some aspects of this disclosure, the information may be derived from the private key of the unique public/private key pair of the node, while in other situations the information need not be derived from the private key itself, and a cryptographic signature of the node may be generated by using the private key of the unique public/private key pair of the node to sign a network address of a subsequent node among nodes 108A-108D to which the transaction is routed by the node.

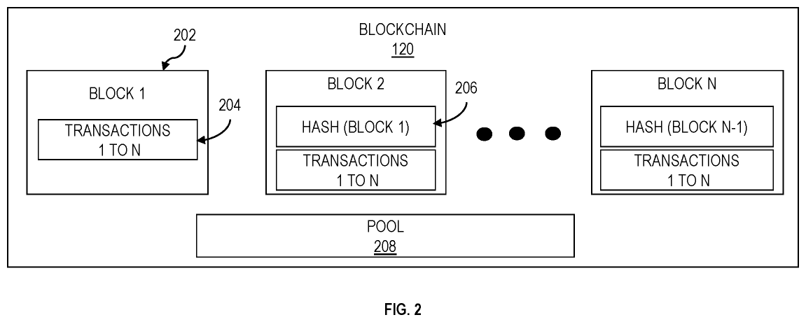

According to some aspects of this disclosure, although node 108A is shown and described in greater detail than nodes 108B-108D, nodes 108B-108D may be similarly configured and perform similarly and/or execute/operate with the same functionality. Node 108A may include a storage module 116 that stores at least a portion of a ledger 118 of a blockchain 120. FIG. 2 shows an example of blockchain 120 in greater detail. Blockchain 120 includes a plurality of blocks 202. Each block 202 is a data structure that includes data representing transactions 204 (e.g., plain text described transactions, etc.) related to and/or including plain text smart contracts, payment receipts, and/or any other transaction. As new transactions 204 are submitted to blockchain 120 and validated, additional blocks 202 are generated and appended to blockchain 120. According to some aspects of this disclosure, each new block 202 may also include a hash 206 of the immediately previous block 202. For example, block 2 includes a hash of block 1, block n includes a hash of block n−1, etc.

According to some aspects of this disclosure, blockchain 120 may include a pool 208. Pool 208 may be associated with a node (e.g., nodes 108A-108D, etc.) storing blockchain 120. Each node (e.g., nodes 108A-108D, etc.) storing blockchain 120 may have a slightly different version of pool 208. Pool 208 may be and/or may store a collection of unconfirmed transactions waiting to be included in a block of blockchain 120. For example, when a user of user device 104 initiates a transaction (e.g., a plain text-described transaction, etc.), the transaction may be broadcasted to and/or received by nodes 108A-108D. Before the transaction is added to a block of blockchain 120, it may reside in pool 208. Pool 208 may store any valid transactions. Invalid transactions may be immediately discarded from blockchain 120.

Referring to FIGS. 1 and 2, ledger 118 includes any data blocks that have been validated and added to blockchain 120. According to some aspects of this disclosure, nodes 108A-108D may each store the entire ledger 118 or a portion of ledger 118. According to some aspects of this disclosure, some or all of blockchain 120 may be stored in a centralized manner. Nodes 108A-108D may communicate with each other to transmit and receive data related to ledger 118. For example, as new data blocks are added to blockchain 120 of ledger 118, nodes 108A-108D may communicate or share the new blocks 202. For example, as new blocks 202 are generated by a validator node of nodes 108A-108D, the validator node may communicate and/or share the new blocks 202 and exchange consensus information regarding blocks 202.

For example, according to some aspects of this disclosure, any transactions submitted to blockchain 120 are validated by at least a portion of nodes 108A-108D designated validator nodes. For example, plain text described transactions may be transmitted to one or more validator nodes of nodes 108A-108D and may be shared between the validator nodes for validation and consensus. Each validator node may determine whether a plain text described transaction is valid and whether the transaction complies with the rules of blockchain 120. The validator node may add a plurality of the validated plain text described transactions to a block 202 and submit the block 202 for consensus by all or some of the other validator nodes. Other validator nodes may then vote “for” or “against” appending a block 202 containing the plain text described transactions to the blockchain 120. A consensus of the set of validator nodes of nodes 108A-108D, e.g., a threshold number of identical votes “for” or “against”, is required to allow or deny a block 202 to be appended to blockchain 120. According to some aspects of this disclosure, nodes of nodes 108A-108D that are not validator nodes may perform operations including, but not limited to, receiving transaction submissions and supporting distributed services of system 100.

According to some aspects of this disclosure, transaction consensus information may be generated using various consensus protocols that include, but are not limited to, Byzantine Fault Tolerance (BFT), Proof of Work (PoW), Proof of Stake (PoS), Proof of Authority (PoA), and/or the like. According to some aspects of this disclosure, any existing consensus protocol may be modified such that nodes 108A-108D not only validate transactions according to cryptographic proofs but also according to a plain text interpretation of the transaction performed via a large language model (LLM)) associated with the node.

In an example scenario, user device 104 and user device 106 may be associated with users/entities that are parties to a legal contract, binding agreement, and/or the like. For example, user device 104 may be associated with a borrower and user device 106 may be associated with a lender. For example, a user may access user device 104 utilizing access credentials that, when entered, cause the display of a user interface associated with a borrower. The user interface may enable the user/borrower to provide details about the user/borrower, indicate assets associated with the user/borrower, and/or provide other information, such as a plain text request in association with acquiring a loan.

A user may access user device 106 utilizing access credentials that, when entered, cause the display of a user interface associated with a lender. The user interface associated with a lender may enable the user/lender to generate, access, review, and/or manipulate loans that the user/lender is associated with. The user interface associated with a lender may enable the user/lender to access, review, and/or manipulate loan applications that are still in process. The user interface associated with a lender may enable the user/lender to view collateral data associated with a user/borrower. The user interface associated with a lender may enable the user/lender to communicate with and/or exchange data with, a user/borrower, a payment network, third-party data systems associated with loans and similar data, and/or the like.

Users may submit smart contracts in plain text form, similar to how a user would write a traditional legal contract, binding agreement, and/or the like. According to some aspects of this disclosure, a user interface of user device 106 may be associated with a lender and may enable the user/lender to create a smart contract as a transaction of the form:

“create ‘Example Loan Agreement 123’ between
Lender=0x4bbeEB066eD09B7AEd07bF39EEe0460DFa261520 and
Borrower=0x4bbeEB066eaaa00009EEe0460DFa261520 for
loanSum=$1,500.
Call it ‘Example Loan Agreement 123’.UUID.”

The plain text described transaction above is a directive and/or command to generate a loan agreement document titled “Example Loan Agreement 123” with a universally unique identifier (UUID). The loan agreement is between a lender (e.g., user of user device 106, etc.) identified by a unique alphanumeric string “0x4bbeEB066eD09B7AEd07bF39EEe0460DFa261520” and a borrower (e.g., user of user device 104, etc.) identified by a unique alphanumeric string “0x4bbeEB066eaaa00009EEe0460DFa261520.” The amount of the loan is for “$1500.00.”

Execution of the described plain text smart contract may result in a deployment to at least one of nodes 108A-108D. For example, when operating as a validating node, node 108A may fetch and/or retrieve the plain text smart contract titled “Example Loan Agreement 123” based on the UUID and verify the plain text smart contract against an original template for the plain text smart contract. Storage module 116 may store templates for plain text contracts.

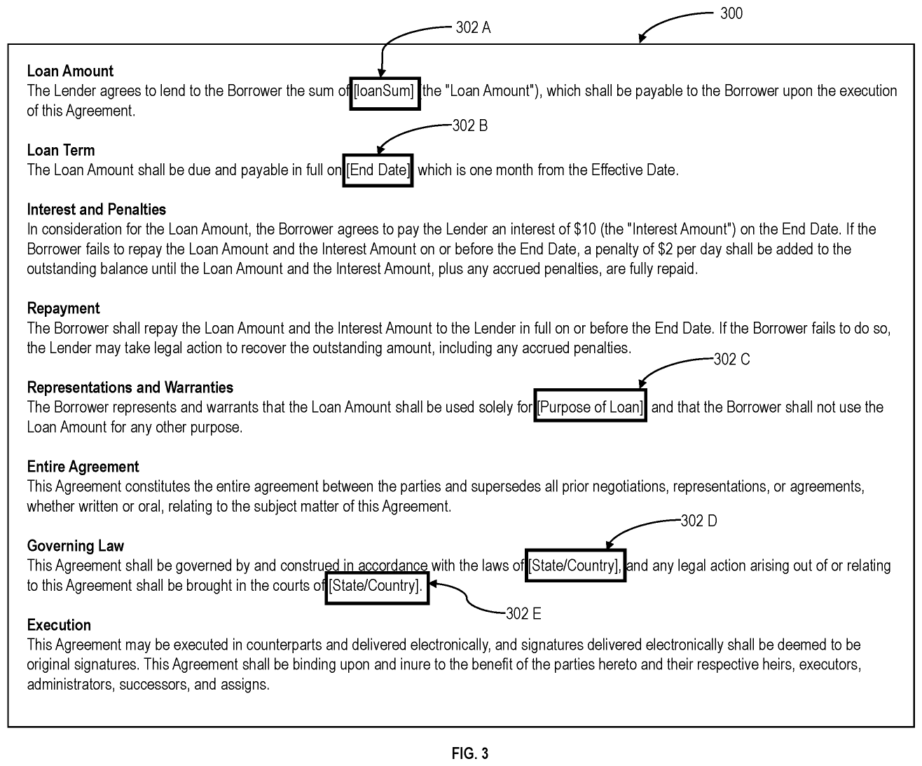

FIG. 3 shows an example of a plain text smart contract template 300. Template 300 may include fields 302A-302E and/or other portions that may be compared to portions of a plain text smart contract to verify that the plain text smart contract adheres to any rules, clauses, stipulations, requirements, etc. of a legal contract, binding agreement, and/or the like.

Returning to FIG. 1, according to some aspects of this disclosure, to verify that the plain text smart contract adheres to any rules, clauses, stipulations, requirements, etc. of a legal contract, binding agreement, and/or the like each node used to validate and/or verify transactions may include a large language model (LLM) that interprets plain text and converts it to a structured set of actions that can be executed by a blockchain.

According to some aspects of this disclosure, a user interface of user device 104 may be associated with a borrower and when the borrower is ready to pay off all or portions of the amount due of “Example Loan Agreement 123,” user device 104 sends the following plain text description of a transaction, “Pay off $500 of the loan I owe on Example Loan Agreement 123.” The plain text description of a transaction may include the UUID for Example Loan Agreement 123.

Validating nodes of nodes 108A-108D may look up the transactions related to “Example Loan Agreement 123” and calculate the running totals. Respective large language models may operate to validate, verify, and/or execute transactions and contracts stored in plain text. According to some aspects of this disclosure, enabling nodes to store transactions and contracts in plain text enables the transactions and contracts to be easily readable without the need to decipher and/or decode programming codes such as Solidity and/or the like. Blockchain 120 remains immutable and cryptographically protected.

For example, node 108A may include a large language model (LLM) 122. LLM 122 may interpret the plain text of a smart contract and/or plain text description of a transaction. According to some aspects of this disclosure, LLM 122 may validate plain text smart contracts (and/or transactions) by interpreting the natural language and ensuring consensus with a natural language interpretation of a template (or stored transaction). Interpreted plain text smart contracts (and/or transactions) may be tested according to different scenarios to ensure correct behavior. According to some aspects of this disclosure, LLM 122 may convert a natural language description of a plain text of a smart contract and/or plain text description of a transaction into a structured representation that captures the intent, obligations, and/or conditions of the plain text of a smart contract and/or plain text description of a transaction, then generate smart contract code and/or transaction code to be shared between nodes for execution, validation, and/or the like based on the structured representations.

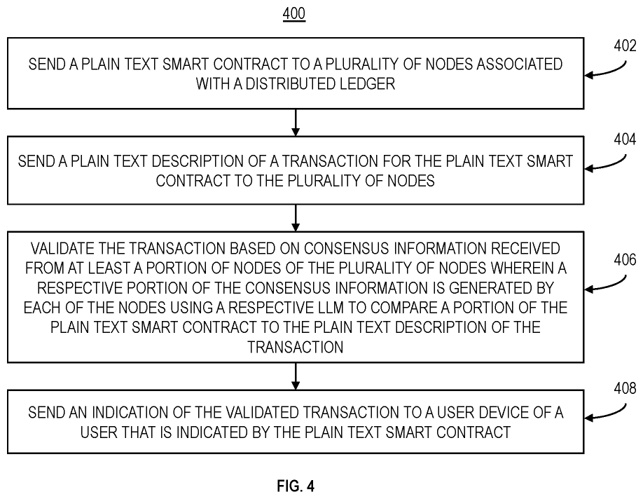

FIG. 4 shows a flowchart of an example method 400 for managing plain text smart contracts, according to some aspects of this disclosure. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Method 400 shall be described with reference to FIGS. 1-3. However, method 400 is not limited to the aspects of those figures.

In 402, node 108A sends to a plurality of nodes associated with a distributed ledger a plain text smart contract. Each node of the plurality of nodes may be associated with a respective large language model trained to interpret plain text. According to some aspects of this disclosure, each node of the plurality of nodes may verify the plain text smart contract using the respective large language model for the node. For example, the respective large language model for each node of the plurality of nodes may compare the plain text smart contract to a plain text template stored by the node.

According to some aspects of this disclosure, each node of the plurality of nodes may store the plain text template and the plain text smart contract associated with a universally unique identifier (UUID) and/or the like. The UUID may be used to identify the plain text smart contract in storage.

According to some aspects of this disclosure, the plain text smart contract and/or plain text template may be a plain text representation of a legal contract that binds its party members to an agreement.

In 404, node 108A (or another node of the plurality of nodes) sends a plain text description of a transaction for the smart contract to the plurality of nodes. According to some aspects of this disclosure, the plain text description of the transaction is verified by the respective large language model for each node of the plurality of nodes (or at least a portion of the plurality of nodes).

For example, in a scenario where the plain text smart contract represents a loan agreement between a borrower (e.g., a user/entity associated with user device 104, etc.) and a lender (e.g., a user/entity associated with user device 106, etc.), and the borrower is ready to pay off all or portions of an amount due according to the loan agreement, the borrower may use a user device (e.g., user device 104, etc.) to submit a plain text description of a transaction such as “Pay off $500 of the loan I owe on Example Loan Agreement 123.” The plain text description of the transaction may indicate the smart contract by including the UUID of the plain text smart contract.

In 406, node 108A (or another node of the plurality of nodes) validates the transaction. According to some aspects of this disclosure, the transaction may be validated based on consensus information received from at least a portion of nodes of the plurality of nodes. According to some aspects of this disclosure, a respective portion of the consensus information may be generated by each node of the at least the portion of nodes based on at least a portion of the plain text smart contract stored by the node. The portion of the plain text smart contract stored by the node may be compared to the plain text description of the transaction by the respective large language model. The respective large language model for each node of at least the portion of nodes may validate that the plain text description of the transaction applies to and/or satisfies a condition of at least a portion of the plain text smart contract stored by the node.

According to some aspects of this disclosure, the consensus information may be generated according to a consensus protocol between at least the portion of nodes of the plurality of nodes. The consensus protocol may include, but is not limited to, Byzantine Fault Tolerance (BFT), Proof of Work (PoW), Proof of Stake (PoS), Proof of Authority (PoA), and/or the like.

According to some aspects of this disclosure, the consensus information may include a respective digital signature from each node of the at least the portion of nodes. The digital signatures may be generated using a private key and/or the like for the smart contract.

In 408, node 108A (or another node of the plurality of nodes) sends an indication of the validated transaction to the user device (e.g., user device 104, etc.) that submitted the plain text description of the transaction.

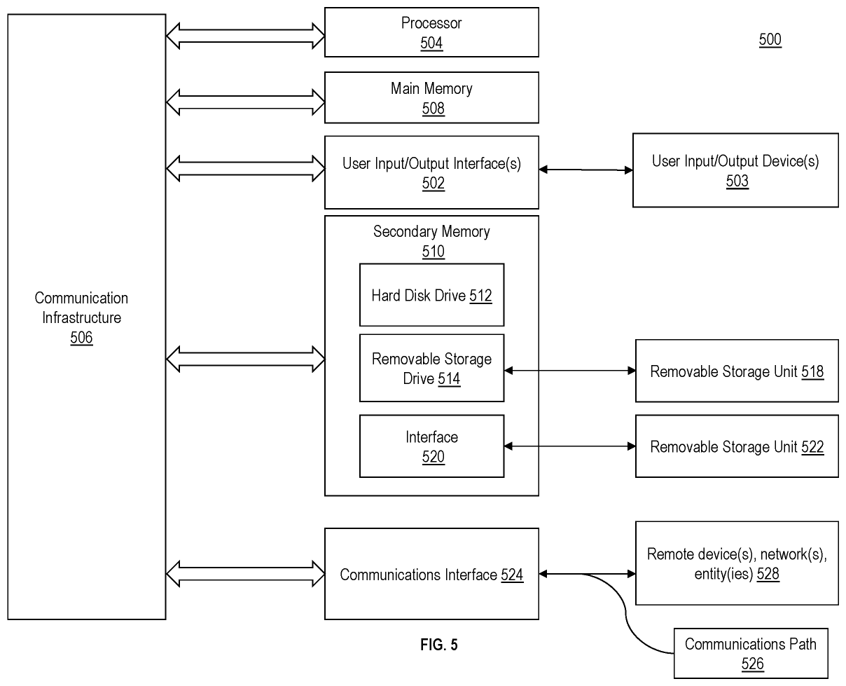

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof. For example, any device and/or component described herein may be implemented via or as one or more computer systems 500.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, a tape backup device, and/or any other storage device/drive.

Removable storage drive 514 may interact with a removable storage unit 518. Removable storage unit 518 may include a computer-usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smartphone, smartwatch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for managing plain text smart contracts comprising:
sending, to a plurality of nodes associated with a distributed ledger, a plain text smart contract, wherein each node of the plurality of nodes is associated with a respective large language model trained to interpret plain text;
sending a plain text description of a transaction for the smart contract to the plurality of nodes; and
validating, based on consensus information received from at least a portion of nodes of the plurality of nodes, the transaction, wherein a respective portion of the consensus information is generated by each node of the at least the portion of nodes based on at least a portion of the plain text smart contract stored by the node compared to the plain text description of the transaction by the respective large language model.

2. The computer-implemented method of claim 1, wherein the plain text smart contract is verified by each node of the plurality of nodes using the respective large language model for the node to compare the plain text smart contract to a plain text template stored by the node.

3. The computer-implemented method of claim 1, wherein the plain text description of the transaction is verified by the respective large language model for each node of the plurality of nodes.

4. The computer-implemented method of claim 1, wherein the consensus information comprises a respective digital signature from each node of at least the portion of nodes generated using a private key for the smart contract.

5. The computer-implemented method of claim 1, wherein the consensus information is based on a consensus protocol between at least the portion of nodes of the plurality of nodes comprising at least one of a Byzantine Fault Tolerance (BFT), Proof of Work (PoW), Proof of Stake (PoS), or Proof of Authority (PoA).

6. The computer-implemented method of claim 1, wherein the sending of the plain text smart contract to the plurality of nodes is based at least in part on a request from a user device of a user that is indicated by the plain text smart contract.

7. The computer-implemented method of claim 1, further comprising sending an indication of the validated transaction to a user device of a user that is indicated by the plain text smart contract.

8. A system, comprising:
a memory; and
at least one processor coupled to the memory and configured to perform operations for managing plain text smart contracts, the operations comprising:
sending, to a plurality of nodes associated with a distributed ledger, a plain text smart contract, wherein each node of the plurality of nodes is associated with a respective large language model trained to interpret plain text;
sending a plain text description of a transaction for the smart contract to the plurality of nodes; and
validating, based on consensus information received from at least a portion of nodes of the plurality of nodes, the transaction, wherein a respective portion of the consensus information is generated by each node of the at least the portion of nodes based on at least a portion of the plain text smart contract stored by the node compared to the plain text description of the transaction by the respective large language model.

9. The system of claim 8, wherein the plain text smart contract is verified by each node of the plurality of nodes using the respective large language model for the node to compare the plain text smart contract to a plain text template stored by the node.

10. The system of claim 8, wherein the plain text description of the transaction is verified by the respective large language model for each node of the plurality of nodes.

11. The system of claim 8, wherein the consensus information comprises a respective digital signature from each node of at least the portion of nodes generated using a private key for the smart contract.

12. The system of claim 8, wherein the consensus information is based on a consensus protocol between at least the portion of nodes of the plurality of nodes comprising at least one of a Byzantine Fault Tolerance (BFT), Proof of Work (PoW), Proof of Stake (PoS), or Proof of Authority (PoA).

13. The system of claim 8, wherein the sending of the plain text smart contract to the plurality of nodes is based at least in part on a request from a user device of a user that is indicated by the plain text smart contract.

14. The system of claim 8, further comprising sending an indication of the validated transaction to a user device of a user that is indicated by the plain text smart contract.

15. A non-transitory computer-readable medium having instructions stored thereon that, when executed by at least one computing device, causes the at least one computing device to perform operations for managing plain text smart contracts, the operations comprising:
sending, to a plurality of nodes associated with a distributed ledger, a plain text smart contract, wherein each node of the plurality of nodes is associated with a respective large language model trained to interpret plain text;
sending a plain text description of a transaction for the smart contract to the plurality of nodes; and
validating, based on consensus information received from at least a portion of nodes of the plurality of nodes, the transaction, wherein a respective portion of the consensus information is generated by each node of the at least the portion of nodes based on at least a portion of the plain text smart contract stored by the node compared to the plain text description of the transaction by the respective large language model.

16. The non-transitory computer-readable medium of claim 15, wherein the plain text smart contract is verified by each node of the plurality of nodes using the respective large language model for the node to compare the plain text smart contract to a plain text template stored by the node.

17. The non-transitory computer-readable medium of claim 15, wherein the plain text description of the transaction is verified by the respective large language model for each node of the plurality of nodes.

18. The non-transitory computer-readable medium of claim 15, wherein the consensus information comprises a respective digital signature from each node of at least the portion of nodes generated using a private key for the smart contract.

19. The non-transitory computer-readable medium of claim 15, wherein the consensus information is based on a consensus protocol between at least the portion of nodes of the plurality of nodes comprising at least one of a Byzantine Fault Tolerance (BFT), Proof of Work (PoW), Proof of Stake (PoS), or Proof of Authority (PoA).

20. The non-transitory computer-readable medium of claim 15, wherein the sending of the plain text smart contract to the plurality of nodes is based at least in part on a request from a user device of a user that is indicated by the plain text smart contract, the operations further comprising sending an indication of the validated transaction to the user device.
